(19) United States
(12) Patent Application Publication
(10) Pub. No.: US 2026/0139803 A1
(43) Pub. Date: May 21, 2026

(54) LIGHT STRING WITH ADJUSTABLE LENGTH

(71) Applicant: HSIN-WEI WU, HSINCHU CITY (TW)

(72) Inventor: HSIN-WEI WU, HSINCHU CITY (TW)

(21) Appl. No.: 19/386,075

(22) Filed: Nov. 11, 2025

Related U.S. Application Data
(60) Provisional application No. 63/721,805, filed on Nov. 18, 2024.
(60) Provisional application No. 63/729,481, filed on Dec. 9, 2024.

(51) Int. Cl. F21S 4/10; F21V 19/00; F21V 23/00; F21V 23/02; F21W 131/10; F21W 131/30

(52) U.S. Cl. CPC F21S 4/10; F21V 19/0005; F21V 23/001; F21V 23/02; F21W 2131/10; F21W 2131/30

(57) ABSTRACT

The present disclosure proposes a light string. The light string includes: a first conductive wire; a second conductive wire; and a third conductive wire, wherein the second conductive wire is parallel to the first conductive wire and the third conductive wire throughout an entire length of the second conductive wire. The light string further includes a plurality of light sources, each including two leads, wherein at least one of the two leads of each of the plurality of light sources is electrically coupled to the second conductive wire.

### PRIORITY CLAIM AND CROSS-REFERENCE

This application claims priority to U.S. provisional application No. 63/721,805, filed Nov. 18, 2024, and U.S. provisional application No. 63/729,481, filed Dec. 9, 2024, the disclosures of which are hereby incorporated by reference in their entirety.

### TECHNICAL FIELD

This application relates to a light string, and more particularly, to a light string with an adjustable length for versatile use in indoor and outdoor environments.

### BACKGROUND

Many households have ornamental articles arranged in their living rooms or bedrooms, or hung on doors, fences or balustrades, as decorations. Examples of such ornamental articles include light-emitting pieces, such as light strings. Although types and materials of the light strings have evolved for decades, there are still aspects of the light strings that need further improvement.

### SUMMARY

A first aspect of the present disclosure discusses a light string. The light string includes: a first conductive wire, a second conductive wire, and a third conductive wire, wherein the second conductive wire is parallel to the first conductive wire and to the third conductive wire throughout an entire length of the second conductive wire. The light string further includes a plurality of light sources, each including two leads, wherein at least one of the two leads of each of the plurality of light sources is electrically coupled to the second conductive wire.

A second aspect of the present disclosure discusses a light string. The light string includes: a first conductive wire, a second conductive wire, including a plurality of conductive segments electrically separate from each other, and a third conductive wire. The light string further includes a plurality of light sources, each including two leads, wherein one of the two leads of each of the plurality of light sources is electrically coupled to the first conductive wire, the third conductive wire, or one of the conductive segments of the second conductive wire.

### BRIEF DESCRIPTION OF THE DRAWINGS

Aspects of the present disclosure are best understood from the following detailed description when read with the accompanying figures. It should be noted that, in accordance with the standard practice in the industry, various structures are not drawn to scale. In fact, the dimensions of the various structures may be arbitrarily increased or reduced for clarity of discussion.

FIG. 1 shows a perspective view of a light string, in accordance with some embodiments of the present disclosure.

FIGS. 2A and 2B are an assembled view and an exploded view, respectively, of a light source and a connector of a light string, in accordance with some embodiments of the present disclosure.

FIGS. 3A and 3B are perspective views of a light source, in accordance with some embodiments of the present disclosure.

FIGS. 4A and 4B are perspective views of an upper casing of the connector shown in FIGS. 2A and 2B, in accordance with some embodiments of the present disclosure.

FIGS. 5A and 5B are perspective views of a lower casing of the connector shown in FIGS. 2A and 2B, in accordance with some embodiments of the present disclosure.

FIGS. 6A and 6B are perspective views of a separator of the connector shown in FIG. 2B, in accordance with some embodiments of the present disclosure.

FIGS. 7A and 7B are perspective views of a separator of the connector shown in FIG. 2B, in accordance with some embodiments of the present disclosure.

FIG. 8 is an exploded view of a connector and a resistor, in accordance with some embodiments of the present disclosure.

FIG. 9 is a schematic circuit diagram of a light string, in accordance with some embodiments of the present disclosure.

FIGS. 10A and 10B are an assembled view and an exploded view, respectively, of a transformer of a light string, in accordance with some embodiments of the present disclosure.

FIGS. 11A and 11B are perspective views of an upper casing of the transformer shown in FIGS. 10A and 10B, in accordance with some embodiments of the present disclosure.

FIGS. 12A and 12B are perspective views of a lower casing of the transformer shown in FIGS. 10A and 10B, in accordance with some embodiments of the present disclosure.

FIGS. 13A and 13B are perspective views of an upper clamp of the transformer shown in FIG. 10B, in accordance with some embodiments of the present disclosure.

FIGS. 14A and 14B are perspective views of a spacer of the transformer shown in FIG. 10B, in accordance with some embodiments of the present disclosure.

FIGS. 15A and 15B are perspective views of a fastener of the transformer shown in FIG. 10B, in accordance with some embodiments of the present disclosure.

FIGS. 16A and 16B are schematic diagrams illustrating deployment scenarios for light strings in outdoor and indoor environments, respectively, in accordance with some embodiments of the present disclosure.

In the following detailed description, for purposes of explanation, numerous specific details are set forth in order to provide a thorough understanding of the disclosed embodiments. It will be apparent, however, that one or more embodiments may be practiced without some of these details. In other instances, well-known structures and devices are schematically shown in order to simplify the drawings. Further, like reference numerals across different figures dictate similar features, and therefore a detailed explanation of the similar feature may be provided when such features are first introduced in the disclosure, and are not subsequently repeated.

### DETAILED DESCRIPTION

The following disclosure provides many different embodiments, or examples, for implementing different features of the provided subject matter. Specific examples of elements and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features are not in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, although the terms such as “first,” “second” and “third” describe various elements, components, regions, layers and/or sections, these elements, components, regions, layers and/or sections should not be limited by these terms. These terms may be only used to distinguish one element, component, region, layer or section from another. The terms such as “first, “second” and “third” when used herein do not imply a sequence or order unless clearly indicated by the context.

As used herein, the term “connected” may be construed to mean “electrically connected,” and the term “coupled” may be construed to mean “electrically coupled.” The terms “connected” and “coupled” may also be used to indicate that two or more elements cooperate or interact with each other. The terms “couple” and “connect” used throughout the present disclosure may also refer to physical or electrical linkage between two or more objects. Such objects may also be referred to as being “coupled” or “connected” through exchange of data or information. The “coupled” or “connected” objects may be in direct contact in some cases, or may be in indirect contact through other intervening objects.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the deviation normally found in the respective testing measurements. Also, as used herein, the terms “about,” “substantial” or “substantially” generally mean within 10%, 5%, 1% or 0.5% of a given value or range. Alternatively, the terms “about,” “substantial” or “substantially” mean within an acceptable standard error of the mean when considered by one of ordinary skill in the art. Other than in the operating/working examples, or unless otherwise expressly specified, all of the numerical ranges, amounts, values and percentages such as those for quantities of materials, durations of time, temperatures, operating conditions, ratios of amounts, and the likes thereof disclosed herein should be understood as modified in all instances by the terms “about,” “substantial” or “substantially.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as being from one endpoint to another endpoint or between two endpoints. All ranges disclosed herein are inclusive of the endpoints, unless specified otherwise.

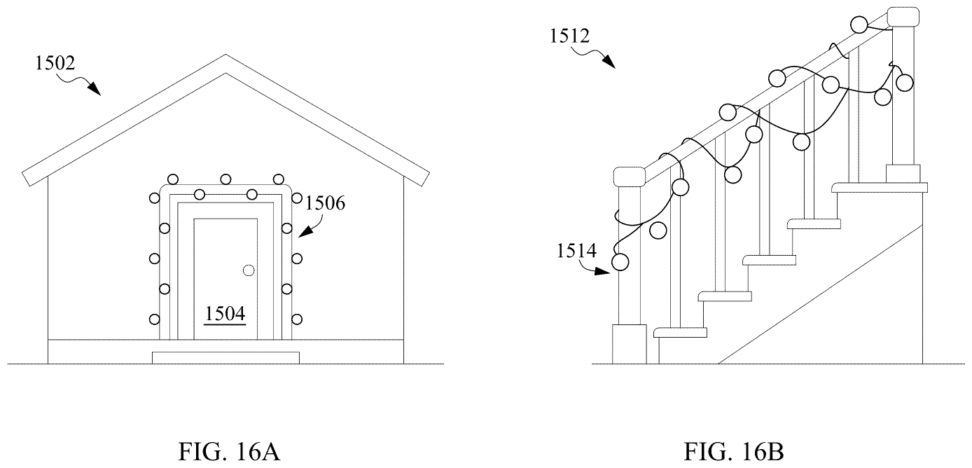

Decorative light strings may be employed in a variety of indoor and outdoor environments to provide illumination, enhance safety, and impart aesthetic value to architectural structures. FIG. 16A illustrates an exemplary outdoor or exterior application in which a house 1502 is provided with a front door 1504, the perimeter of which is outlined by a light string 1506. In the embodiment of FIG. 16A, the light string 1506 is disposed in a manner that traces a contour of the front door 1504, thereby producing a defined boundary and accentuating an entrance of the house 1502. Such a configuration is advantageous in providing a visually distinctive and welcoming effect, particularly during evening hours, festive occasions, or seasonal events. In addition to decorative utility, the light string 1506 may further serve to improve visibility and orientation, guiding individuals toward the front door 1504 and reducing a likelihood of missteps in low-light conditions. The light string 1506 may be implemented with bulbs of varying characteristics, including warm white bulbs to impart an inviting atmosphere, or multicolored bulbs to convey a celebratory appearance. Accordingly, the embodiment of FIG. 16A demonstrates how a positioning of a light string 1506 on an exterior of a building can simultaneously enhance functionality and aesthetic presentation.

FIG. 16B illustrates an exemplary interior application, in which a staircase 1512 is provided with a light string 1514. In the embodiment of FIG. 16B, the light string 1514 is arranged both in a draped configuration along the balusters of the staircase 1512 and also helically wound around a handrail of the staircase 1512. Dual placement of the light string 1514 emphasizes an architectural contour of the staircase 1512 while providing improved illumination of the staircase. Such an arrangement facilitates improved safety by delivering low-level lighting along the walking path of the staircase 1512, thereby assisting residents in navigating the stairway under reduced ambient lighting conditions. In addition, wrapping the light string 1514 around the handrail produces a continuous line of illumination that augments a visual prominence of the staircase 1512 as an architectural feature. From a decorative perspective, combined draped and wrapped configurations of the light string 1514 provide an enhanced ornamental effect suitable for use in residential, commercial, or hospitality settings. For example, the embodiment of FIG. 16B may be particularly applicable during holiday seasons or special events, or as a permanent design feature in spaces where staircases are intended to serve as focal points. In comparison with the outdoor embodiment depicted in FIG. 16A, the embodiment of FIG. 16B demonstrates the adaptability of the light string 1514 to indoor structures, providing both functional lighting utility and aesthetic enhancement. Collectively, the embodiments shown in FIGS. 16A and 16B illustrate the versatility of decorative light strings in highlighting architectural boundaries, improving safety, and contributing to the overall aesthetic character of both outdoor and indoor environments.

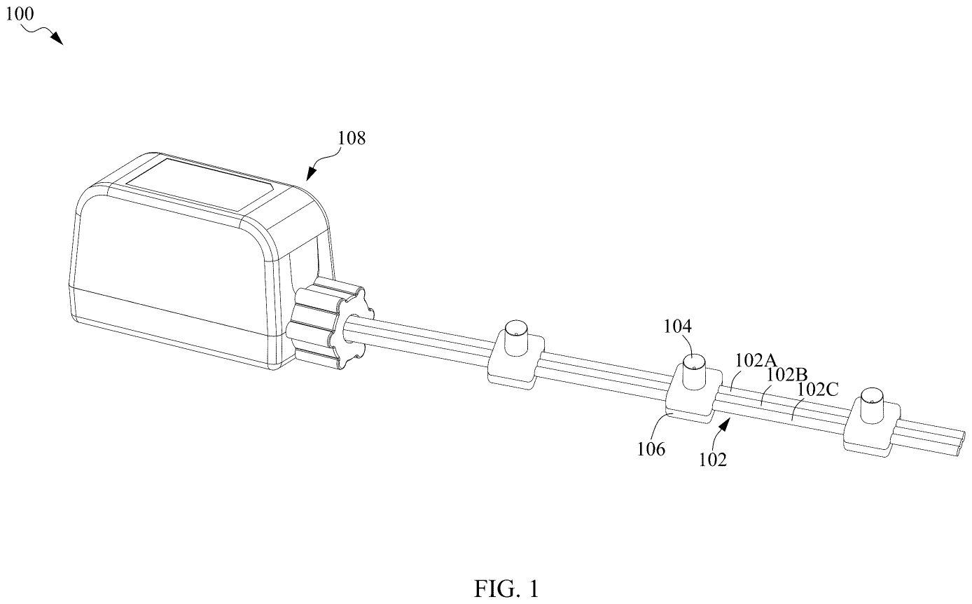

FIG. 1 shows a perspective view of a light string 100, in accordance with some embodiments of the present disclosure. The light string 100 may be applied in the scenarios shown in FIGS. 16A and 16B and correspond to the light string 1506 or 1514. According to some embodiments, the light string 100 includes a ribbon wire 102, a plurality of light sources 104, a plurality of connectors 106, and a transformer 108. The transformer 108 may be coupled to one end of the ribbon wire 102.

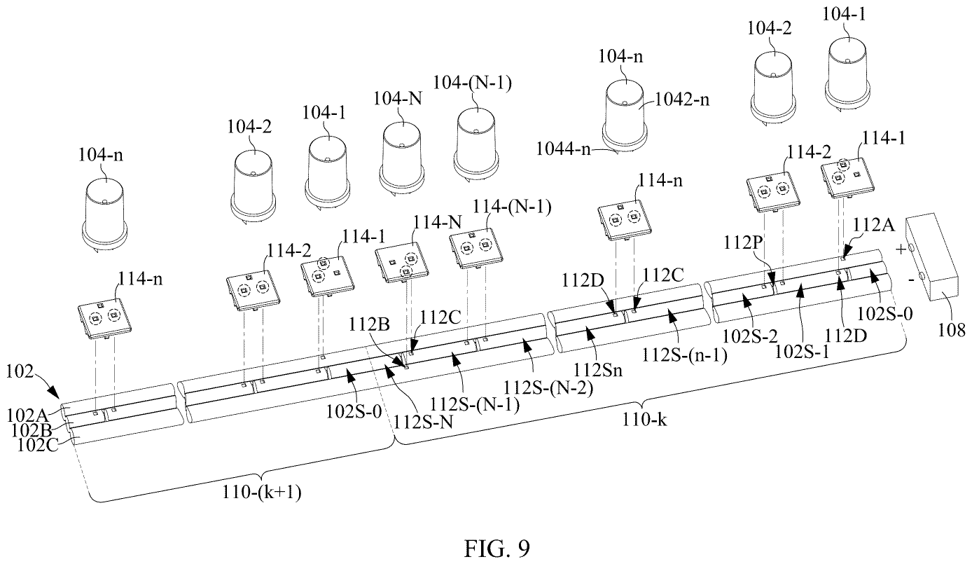

According to some embodiments, the ribbon wire 102 includes a first conductive wire 102A, a second conductive wire 102B and a third conductive wire 102C. The conductive wires 102A, 102B and 102C are formed of flexible materials, and can be bent or flexed as needed. According to some embodiments, the conductive wires 102A, 102B and 102C are arranged parallel to one another. The conductive wires 102A, 102B and 102C are joined side by side in a form of a ribbon cable (wire), a flat cable (wire), a planar cable (wire), a strip cable (wire) or another similar cable type. According to some embodiments, the conductive wires 102A, 102B and 102C collectively form a flat and untwisted plane for the ribbon wire 102. According to some embodiments, the conductive wire 102B is parallel to the conductive wire 102A and the conductive wire 102C throughout an entire length of the conductive wire 102B. According to some embodiments, each of the conductive wires 102A, 102B and 102C includes a conductive core layer and an insulating layer covering the conductive core layer, wherein the conductive core layer is used for connecting the light sources 104 to a supply voltage or ground, and the insulating layer is used to electrically insulate the conductive wires 102A, 102B and 102C from each other and to protect the ribbon wire 102 from external forces. According to some embodiments, the insulating layers of the conductive wires 102A, 102B and 102C are joined together in a parallel manner to form a shape of a ribbon or a substantially flat plane for the ribbon wire 102. Electrical circuits of the light string 100, used for supplying power to the light sources 104 through arrangements of the conductive wires 102A, 102B and 102C, are explained later with reference to FIG. 9.

According to some embodiments, the plurality of light sources 104 are electrically coupled to the conductive wires 102A, 102B or 102C. According to some embodiments, the plurality of connectors 106 are arranged between the ribbon wire 102 and the corresponding light sources 104, wherein the connectors 106 electrically guide the respective light sources 104 to the conductive wires 102A, 102B and 102C.

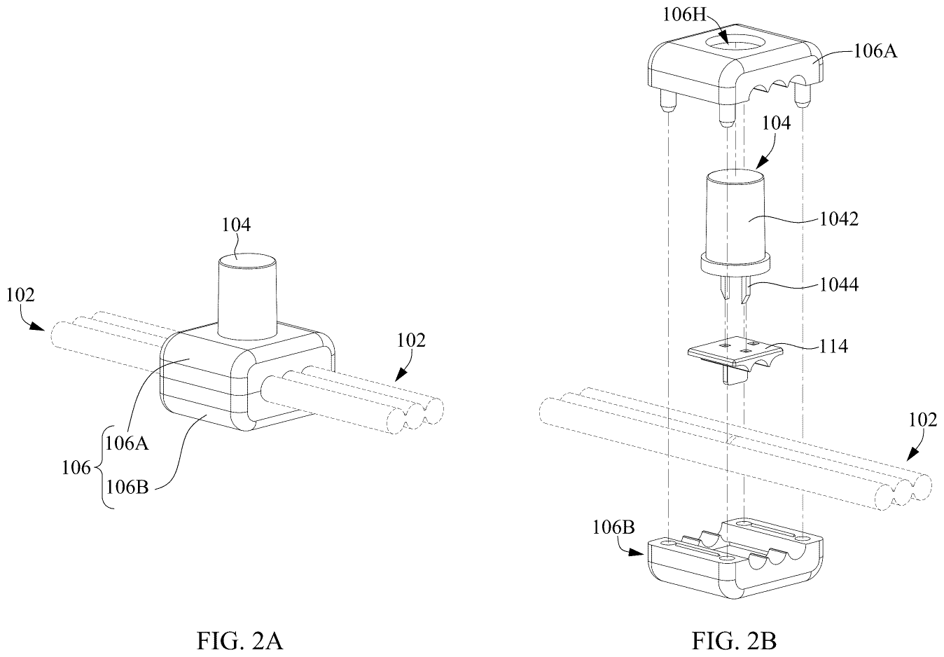

FIGS. 2A and 2B are an assembled view and an exploded view, respectively, of the light source 104 and the connector 106 of the light string 100, in accordance with some embodiments of the present disclosure. Referring to FIG. 2B, the light source 104 includes a light-emitting element 1042 and a plurality of leads 1044 electrically connected to the light-emitting element 1042. According to some embodiments, a number of the leads 1044 is two. According to some embodiments, the connector 106 includes an upper casing 106A, a lower casing 106B, and a separator 114. The leads 1044 of the light source 104 may extend through the upper casing 106A of the connector 106 and reach the conductive core layer of the conductive wire 102A, 102B or 102C.

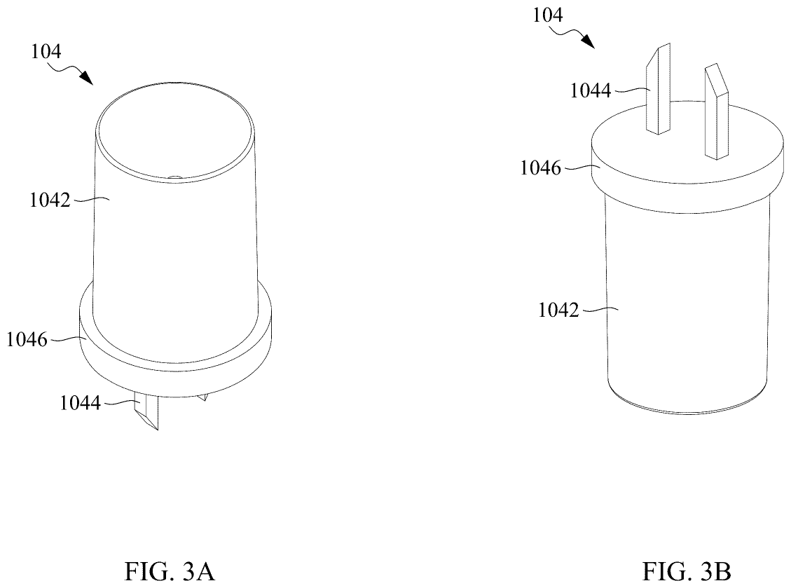

FIGS. 3A and 3B are perspective views of the light source 104, in accordance with some embodiments of the present disclosure. According to some embodiments, the light-emitting element 1042 of the light source 104 is formed of a light-emitting diode (LED), a light bulb, or another suitable light-emitting device. According to some embodiments, the conductive core layers of the conductive wire 102A, 102B or 102C and the leads 1044 are formed of conductive materials, such as aluminum, copper, silver, gold, tungsten, iron, tin, or another suitable conductive material. According to some embodiments, the leads 1044 are formed of a hard material, such as metal, and are configured to extend in a predetermined direction and to support the light-emitting element 1042. According to some embodiments, the leads 1044 are formed of inflexible materials. According to some embodiments, unlike the conductive wires 102A, 102B and 102C, which include an insulating material covering the conductive core layer, the leads 1044 of the light sources 104 are exposed and free of coverage by insulating layers. According to some embodiments, each of the leads 1044 includes one end encapsulated in a pedestal 1046 of the light source 104 and extends outwardly from the pedestal 1046. Referring to FIGS. 2A, 3A and 3B, the light source 104 may be fixed on the upper casing 106A when assembled with the connector 106, wherein the pedestal 1046 may be encapsulated within the upper casing 106A or exposed on an outside of the upper casing 106A. The light-emitting element 1042 may have a cylindrical shape or another suitable shape. The light-emitting element 1042 may be encapsulated and integrated with the pedestal 1046 by an encapsulating material, such as silicone, epoxy resin, or another suitable encapsulating material.

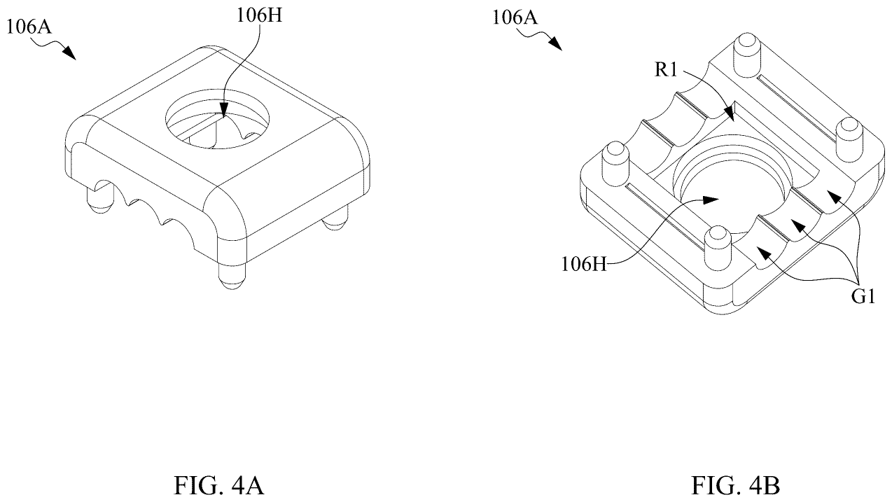

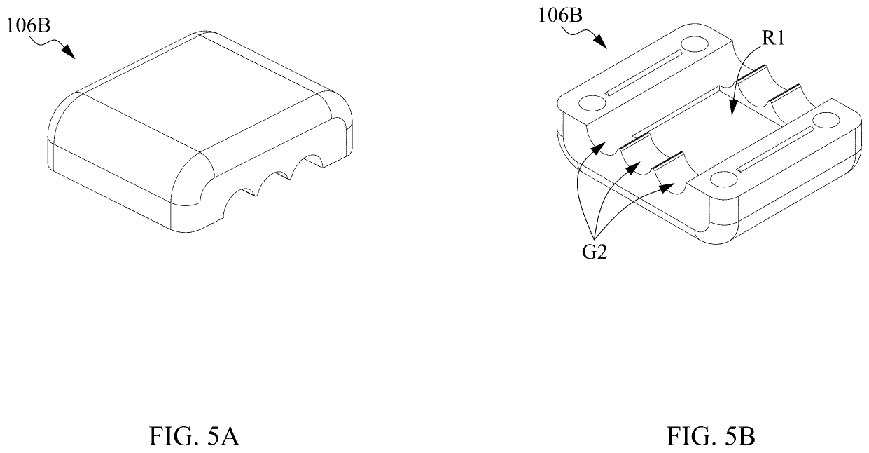

FIGS. 4A and 4B are perspective views of the upper casing 106A of the connector 106 shown in FIGS. 2A and 2B, in accordance with some embodiments of the present disclosure. FIGS. 5A and 5B are perspective views of the lower casing 106B of the connector 106 shown in FIGS. 2A and 2B, in accordance with some embodiments of the present disclosure. According to some embodiments, the connector 106 is used to electrically connect the light source 104 to the conductive wires 102A, 102B and 102C while additionally providing physical support and protection for a connection structure.

The upper casing 106A and the lower casing 106B may be used to form a casing of the connector 106, enclosing the connection structure therein. Referring to FIGS. 2B, 4A and 4B, the upper casing 106A includes a hole 106H extending through the upper casing 106A. The hole 106H may be used to accommodate the light source 104 and to allow the leads 1044 to pass through the upper casing 106A and electrically connect to the conductive wire 102A, 102B or 102C. Further, as shown in FIGS. 4A and 4B, an inner side of the upper casing 106A includes a plurality of grooves G1 corresponding to rounded perimeters of the conductive wires 102A, 102B and 102C. Similarly, as shown in FIGS. 5A and 5B, an inner side of the lower casing 106B includes a plurality of grooves G2 corresponding to the rounded perimeters of the conductive wires 102A, 102B and 102C.

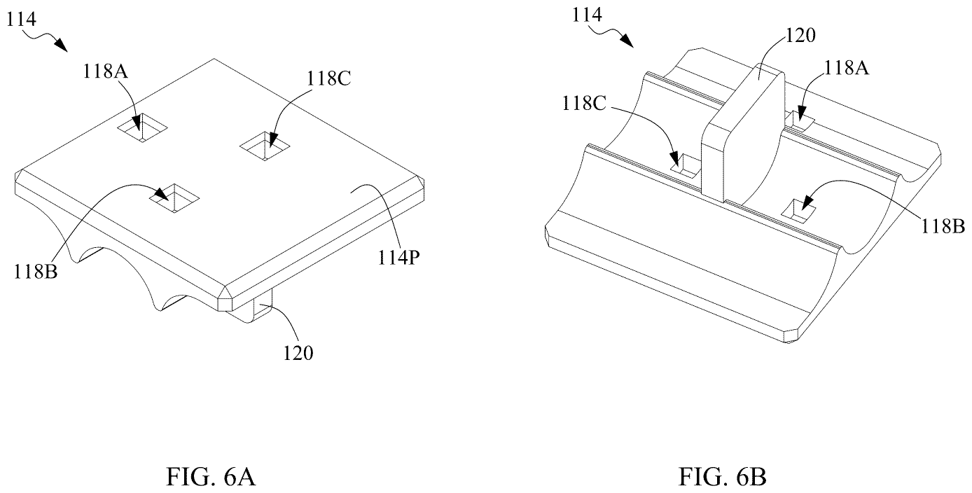

FIGS. 6A and 6B are perspective views of the separator 114 of the connector 106 shown in FIG. 2B, in accordance with some embodiments of the present disclosure. Referring to FIG. 4B, the inner side of the upper casing 106A further includes a recess R1 surrounding the hole 106H. The recess R1 may be located around a center of the inner side of the upper casing 106A and divides each of the plurality of grooves G1 into two aligned and separate grooves. Similarly, referring to FIG. 5B, the inner side of the lower casing 106B further includes a recess R2 around a center of the inner side of the lower casing 106B. The recess R2 may divide each of the plurality of grooves G2 into two aligned and separate grooves.

Referring to FIGS. 2A and 2B, when the upper casing 106A and the lower casing 106B are aligned and fitted together, the recesses R1 and R2 are aligned with each other and accommodate the separator 114 such that the upper casing 106A and the lower casing 106B can form a sealed space with the separator 114 for the leads 1044. According to some embodiments, referring to FIG. 6A, the separator 114 includes a main plate 114P on a first side, in which the main plate 114P includes a rectangular shape or another suitable shape. The recesses R1 and R2 are formed with a size and a shape same as those of the main plate 114P. According to some embodiments, the separator 114 includes a plurality of grooves G3 on a second side of the separator 114 opposite to the first side. In the example shown in FIGS. 2A, 2B and 6B, the ribbon wire 102 is formed of three conductive wires 102A, 102B and 102C, and the separator 114 includes three grooves G3 respectively corresponding to the conductive wires 102A to 102C. When the upper casing 106A and the lower casing 106B are aligned and fitted together from two sides of the ribbon wire 102, the grooves G1 and G3 form contiguous grooves on one side aligned with the grooves G2 on the other side, such that the conductive wires 102A, 102B and 102C can be fitted into the grooves G1, G2 and G3. As a result, the upper casing 106A, the lower casing 106B and the separator 114 can form a sealed space with the conductive wires 102A, 102B and 102C for the leads 1044. In the meantime, the light source 104 and the separator 114 can be tightly secured by the upper casing 106A, the lower casing 106B, and the conductive wires 102A, 102B and 102C.

Referring to FIGS. 6A and 6B, the main plate 114P of the separator 114 includes holes 118, such as holes 118A, 118B and 118C, extending through the separator 114. The holes 118 may also be referred to herein as guide holes. The separator 114 further includes an insulating plate 120 extending in a direction perpendicular to the main plate 114P. When the light source 104 is connected to the conductive wire 102A, 102B or 102C, a planar surface of the pedestal 1046 contacts the main plate 114P, and the holes 118 are used to guide the leads 1044 to pass through the main plate 114P and to connect to the conductive core layer of the conductive wire 102A, 102B or 102C.

According to some embodiments, the hole 118A corresponds to or vertically overlaps one of the conductive wire 102A and the conductive wire 102C, and the holes 118B and 118C correspond to or vertically overlap the conductive wire 102B between the conductive wires 102A and 102C. The holes 118B and 118C are arranged on opposite sides of the insulating plate 120, or the insulating plate 120 is arranged between the holes 118B and 118C.

According to some embodiments, when the plurality of light sources 104 are electrically connected to the ribbon wire 102 through one or more circuits, the two leads 1044 are electrically connected to the conductive wires 102A, 102B and 102C via first, second and third connection modes. The first connection mode causes the two leads 1044 to electrically connect to the conductive wires 102A and 102B, respectively, through the holes 118A and 118B or the holes 118A and 118C. The second connection mode causes the two leads 1044 to electrically connect to two separate conductive segments (the conductive segments 102S, which are described in detail below with reference to FIG. 9) of the conductive wires 102B, respectively, through the holes 118B and 118C. The third connection mode causes the two leads 1044 to electrically connect to the conductive wires 102B and 102C, respectively, through the holes 118A and 118B or the holes 118A and 118C. According to some embodiments, pairs of the holes 118A, 118B and 118C are separated by substantially equal distances, e.g., the distance between the holes 118A and 118B is substantially equal to the distance between the holes 118B and 118C, such that the two leads 1044 of any one of the light sources 104 can be arranged in any of the three connection modes using a single design of the proposed separator 114. According to some embodiments, for all of the three connection modes, at least one of the leads 1044 of each of the light sources 104 is electrically coupled to the conductive wire 102B, which is a middle conductive wire of the ribbon wire 102.

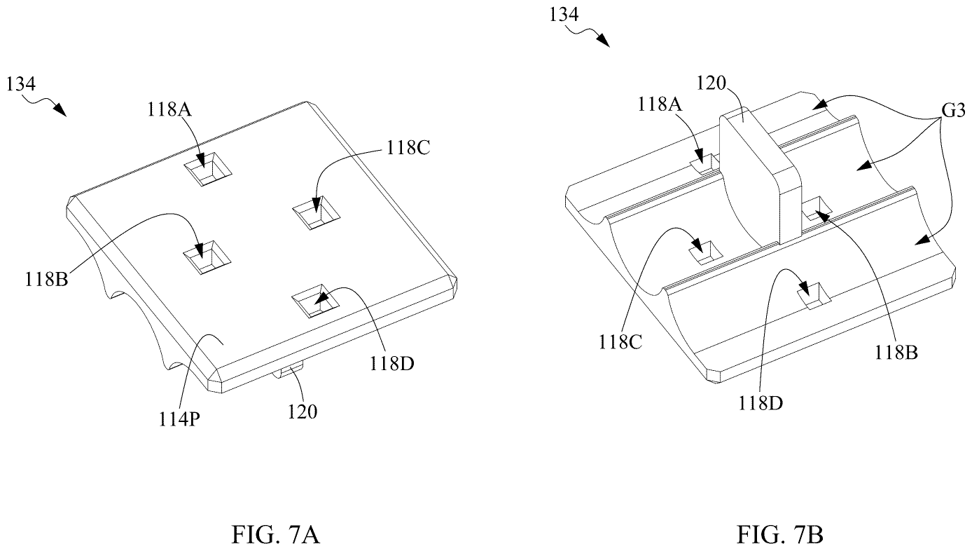

FIGS. 7A and 7B are perspective views of a separator 134 of the connector 106 shown in FIG. 2B, in accordance with some embodiments of the present disclosure. The separator 134 shown in FIGS. 7A and 7B is similar in many respects to the separator 114 shown in FIGS. 6A and 6B, and repeated descriptions of similar features are omitted herein for brevity. Referring to FIGS. 7A and 7B, the main plate 114P of the separator 134 includes a hole 118D. The holes 118A and 118D are arranged such that one of the holes 118A or 118D corresponds to or vertically overlaps the conductive wire 102A, while another of the holes 118A or 118D corresponds to or vertically overlaps the conductive wire 102C. A method of using the separator 134 shown in FIGS. 7B and 7B is substantially identical to a method of using the separator 114 shown in FIGS. 6A and 6B. That is, when the plurality of light sources 104 are electrically connected to the ribbon wire 102 through one or more circuits, the two leads 1044 are electrically connected to the conductive wires 102A, 102B and 102C via the three connection modes. However, caution should be exercised regarding a location of the separator 114 in a circuit for connecting the plurality of light sources 104. That is because the hole 118A should correspond to a correct conductive wire 102A or 102C depending on whether the light source 104 is used in the first connection mode or the third connection mode. In contrast, the separator 134 is more direction friendly than the separator 114 since it has holes 118A and 118D corresponding to the conductive wires 102A and 102C respectively. Thus, the separator 134 can be installed in either direction, and connection functionality of the two installation directions is the same. As a result, a risk of circuit failure due to an error in installation of the separator 114 can be eliminated.

Referring to FIGS. 1, 6A, 6B, 7A and 7B, since the main plate 114P of the separator 114 is substantially parallel to the plane of the ribbon wire 102, the leads 1044 of the light source 104 are substantially perpendicular to the ribbon wire 102, i.e., perpendicular to the conductive wires 102A, 102B and 102C. Further, referring to FIGS. 1, 2A and 2B, the separators 114 guide the conductive wires 102A, 102B and 102C through the separators 114 along the grooves G1, G2 and G3, and the conductive wires 102A, 102B and 102C enter the connector 106 from a first side of the connector 106 and exit the connector 106 from a second side of the connector 106, wherein the first side and the second side are opposite to each other and substantially perpendicular to the ribbon wire 102.

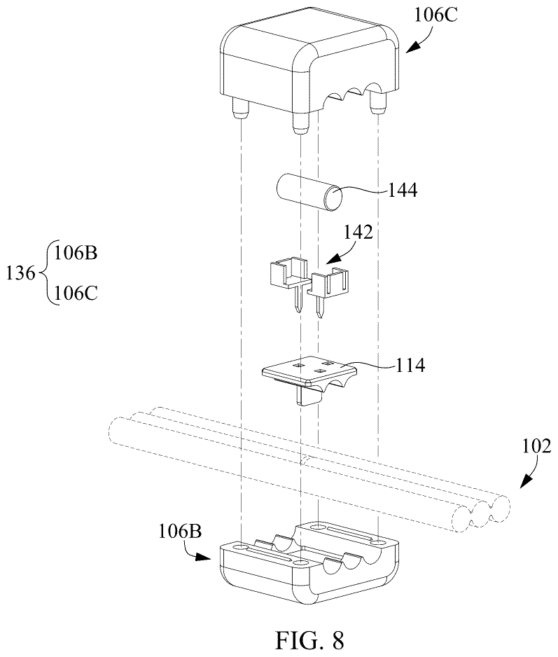

FIG. 8 is an exploded view of a connector 136 and resistor 144, in accordance with some embodiments of the present disclosure. The connector 136 includes an upper casing 106C and a lower casing 106B. The lower casing 106B shown in FIG. 8 is similar to the lower casing 106B shown in FIGS. 5A and 5B in many respects, and descriptions of these similar features are omitted for brevity. The upper casing 106C is similar to the upper casing 106A shown in FIGS. 4A and 4B, and a difference between the upper casing 106C and the upper casing 106A is that the upper casing 106C is free of any hole on its upper surface. That is because the connector 136 is used for incorporating the resistor 144, rather than the light source 104, into the circuit of the light string 100. The upper casing 106C and the lower casing 106B are fit together to secure the resistor 144 in place and cause electrical connection between the resistor 144 and the conductive wire 102.

According to some embodiments, the resistor 144 is formed of a two-terminal resistive element, and may include carbon, metal, metal oxide, ceramics, or another suitable resistive material. The resistor 144 may be incorporated into the circuit of the light string 100 by taking place of one light sources 104. When the voltage provided by the transformer 108 is higher than the rated voltage of the light sources 104, the resistor 144 may be used to absorb the excess voltage drop across the light string 100, thereby ensuring that each light source 104 receives the correct operation voltage. According to some embodiments, the resistor 144 is used to control the current flowing through the light sources 104 to prevent excessive current flow.

According to some embodiments, the connector 136 further includes two couplers 142. Each of the couplers 142 include a holder and a pin (or lead) connected to the holder. The holder may include three lateral sides and a bottom side connected to the lateral sides. Each holder of the two couplers 142 is used to accommodate and electrically connect to a terminal of the resistor 142. Each pin of the couplers 142 is used to electrically connect the holder and the contact of the conductive wire 102B through the separator 114. The holder and the pin of the coupler 142 may be formed of conductive materials, such as copper, aluminum, or another suitable metal.

FIG. 9 is a schematic circuit diagram of the light string 100, in accordance with some embodiments of the present disclosure. According to some embodiments, the transformer 108 is configured to supply power and ground to the light sources 104 through the ribbon wire 102. Among the conductive wires 102A, 102B and 102C, the conductive core layers of the conductive wire 102A and the conductive wire 102C are formed of contiguous, non-interrupted conductive cords or lines throughout an entire length of the conductive wires 102A, 102B and 102C. Further, the conductive core layer of the (middle) conductive wire 102B, arranged between the conductive wires 102A and 102C, is partitioned into a plurality of conductive segments 102S physically and electrically separate from one another. Each conductive segment 102S of the core conductive layer of the conductive wire 102B are parallel to other conductive segments 102S when the conductive wire 102B is stretched straight. Referring to FIGS. 2B and 7, when the separator 114 is incorporated into the connector 106, the insulating plate 120 of the separator 114 is inserted into a space 112P between adjacent conductive segments 102S to provide physical isolation and electrical insulation between adjacent conductive segments 102S.

According to some embodiments, the transformer 108 includes a first terminal (+) and a second terminal (−) configured to supply a power signal and a ground reference (e.g., zero volts) to the ribbon wire 102. The power signal is supplied with a predetermined voltage and current to comply with a circuit specification of the light sources 104. In some embodiments, the transformer 108 may be replaced by a plug (not separately shown) configured to receive power from mains electricity. A voltage of the mains electricity may be about 110 volts or 220 volts, and a voltage of the transformer 108 may be between about 20 volts and about 50 volts, such as 24 volts. The current received from the mains electricity may be alternating current (AC), while the current provided by the transformer 108 may be direct current (DC).

Referring to FIG. 9, the plurality of light sources 104 are divided into a plurality of subsets. All the light sources 104 of each subset constitute a serial-connection circuit 110 and are connected through serial connection. For example, the embodiment of the light string 100 shown in FIG. 9 includes an example serial-connection circuit 110-k having N light sources 104-1, 104-2, . . . , 104-n, 104-N, wherein the indices k, n, and N are positive integers. In some embodiments, the power signal of the transformer 108 is supplied to the conductive wire 102A, and the ground reference of the transformer 108 is supplied to the conductive wire 102C. In other embodiments, the power signal of the transformer 108 is supplied to the conductive wire 102C, and the ground reference of the transformer 108 is supplied to the conductive wire 102A.

A first light source 104-1 (referred to herein as a first-type light source 104) of the serial-connection circuit 110-k is electrically connected to the serial-connection circuit 110-k by connecting the two leads 1044 to a contact 112A on the conductive wire 102A and a contact 112D on a conductive segment 102S-1 of the conductive wire 102B, respectively. The contact 112A or 112C may not be directly shown in FIG. 9. However, FIG. 9 illustrates vias on the insulating layer of the conductive wire 102A or 102B that expose contacts 112A, 112B, 112C and 112D. According to some embodiments wherein the power signal is supplied to the conductive wire 102A, the lead 1044 connected to the conductive wire 102A is supplied with a high voltage, while the lead 1044 connected to the conductive segment 102S-1 of the conductive wire 102B is connected to a low voltage. According to some embodiments, referring to FIGS. 6A, 6B, 7A and 7B, one of the two leads 1044 is connected to the conductive wire 102A through the hole 118A of the separator 114-1, or through the hole 118A or 118D of the separator 134-n, and another of the two leads 1044 is connected to the conductive segment 102S-1 through the hole 118B or 118C, as marked by circled holes of the separator 114-1.

Each of the intermediate light sources 104-n from the light source 104-2 to the light source 104-(N−1) (referred to herein as a second-type light source 104) of the serial-connection circuit 110-k is electrically connected to the serial-connection circuit 110-k by connecting the two leads 1044 to contacts 112C and 112D on adjacent conductive segments 102S-(n−1) and 102S-n of the conductive wire 102B, respectively. According to some embodiments wherein the power signal is supplied to the conductive wire 102A, the lead 1044 connected to the conductive segment 102S-(n−1) is supplied with a high voltage, while the lead 1044 connected to the conductive segment 102S-n is connected to a low voltage. According to some embodiments, referring to FIGS. 6A, 6B, 7A and 7B, the two leads 1044 are connected to the conductive segments 102S-(n−1) and 102S-n through the holes 118B and 118C of the separator 114-n or 134, as marked by circled holes of the separator 114-n. As shown in FIG. 9, the holes 118B and 118C of each separator 114-n are arranged on opposite sides of the insulating plate 120, and correspond to or vertically overlap two adjacent conductive segments 102S-(n−1) and 102S-n.

A last light source 104-N (referred to herein as a third-type light source 104) of the serial-connection circuit 110-k is electrically connected to the serial-connection circuit 110-k by connecting the two leads 1044 to a contact 112B on the conductive wire 102C and a contact 112C on a conductive segment 102S-(N−1), respectively. According to some embodiments wherein the power signal is supplied to the conductive wire 102A, the lead 1044 connected to the conductive segment 102S-(N−1) is supplied with a high voltage, while the lead 1044 connected to the conductive wire 102C is connected to a low voltage. According to some embodiments, referring to FIGS. 6A, 6B, 7A and 7B, one of the two leads 1044 is connected to the conductive wire 102C through the hole 118A of the separator 114-N, or through the hole 118A or 118D of the separator 134, and another of the two leads 1044 is connected to the conductive segment 102S-(N−1) through the hole 118B or 118C, as marked by circled holes on the separator 114-N.

According to some embodiments, each of the conductive segments 102S-1 to 102S-(N−1) includes two contacts 112C and 112D configured to receive corresponding leads 1044 of the light sources 104. Each of the contacts 112C and 112D may be formed as a hole allowing the lead 1044 to pass through and electrically connected thereto, e.g., through solder connectors or another suitable conductive connector. Alternatively, each of the contacts 112C and 112D can be formed as a recess or a bump suitable for receiving the corresponding lead 1044 and forming a stable connection thereto. According to some embodiments, a space between the leads 1044 and the holes 118 is filled by an adhesive or glue material, or a solder material.

Referring to FIGS. 6A, 6B, and 9, one or more locations in the light string 100 for the light sources 104 are replaced with the resistor 144 where appropriate. The resistor 144 is to be incorporated into the light string 100 with a configuration similar to the second-type light sources. In other words, two pins of the two couplers 142 extends through the holes 118B and 118C respectively and reach the contacts 112C and 112D of adjacent conductive segments 102S-(n−1) and 102S-n, respectively, of the conductive wire 102B.

Based on the above configuration, the serial-connection circuit 110-k forms a closed circuit from the conductive wire 102A to the conductive wire 102C through the intervening N light sources 104 and consecutive N−1 conductive segments 102S, wherein the light sources 104 and the conductive segments 102S are connected via serial connection. Due to a nature of serial connection, any failure occurring to any of the conductive segments 102S, the light sources 104 or the connections among these elements will cause failure of the entire serial-connection circuit 110-k.

The light string 100 can be extended by repeating the serial-connection circuit 110 several times, wherein different serial-connection circuits 110-k share a same power signal and a ground voltage supplied by the first terminal (+) and the second terminal (−), respectively, of the transformer 108. In such configurations, multiple serial-connection circuits 110k are connected to the transformer 108 through parallel connection.

The proposed light string 100 can be made with an arbitrary length by cutting short an original light string of an extremely large length into a desired length. A cutting point of the light string 100 should be located outside each of the serial-connection circuits 110-k to prevent circuit failure of an interrupted serial-connection circuit 110-k. According to some embodiments, each conductive segment 102S-N or 102S-0, which is located between adjacent serial-connection circuits, e.g., between the conductive segment 102S-(N−1) of the serial-connection circuit 110-k and the conductive segment 102S-1 of the serial-connection circuit 110-(k+1), is kept electrically floating (not grounded) and does not belong to any serial-connection circuit. Moreover, a circuit integrity of the serial-connection circuit 110-(k+1) is kept intact after the cutting from the conductive segment 102S-N or 102S-0. A remaining portion of the original long light string is not damaged in its entirety, and can be used in another new light string without sacrifice of any circuits or light sources 104. A utilization efficiency of the original long light string is maximized accordingly. Thus, the conductive segment 102S-N or 102S-0 can serve as a region for cutting the light string 100 without impacting operation of the original circuits.

As discussed above, the original, uncut light string can be formed to an arbitrary length by determining a suitable number of a single serial-connection circuit and/or a number of serial-connection circuits. The shortened light string 100 of a desired length can be obtained as long as the voltage/current specifications of the transformer 108 can meet the requirements of the light sources 104 of the light string 100. As a result, the proposed light string 100 can have an adjustable length that fulfills various length requirements for different application scenarios. According to some embodiments, a customer can purchase a custom-made light string 100 of a desired length cut from an original long light string manufactured according to the present disclosure. A cutting position should be located between adjacent serial-connection circuits 110, such as the region within the conductive segment 102S-N or 102S-0 as shown in FIG. 9.

The proposed light string 100 provides advantages. For example, since a minimal functioning unit of the light string 100 is a single serial-connection circuit 110, the proposed light string 100 can be made to a minimal length by including only a few light sources 104, e.g., eight light sources 104. In addition, since a number of the light sources 104 can be arbitrarily increased by adding more of the serial-connection circuits 110 in parallel connection, the proposed light string 100 can be made relatively long, e.g., greater than 1,000 feet, which is much longer than a single decorative light string according to existing commercial configurations.

The proposed light string 100 features the ribbon-type wire 102, making it possible to manufacture the light string 100 with a relatively greater length using existing wire manufacturing processes. In contrast, in existing decorative light strings having three conductive wires to provide connection circuits for the light sources, the three conductive wires need to be twisted together to form a twisted cable or wire to provide sufficient durability and electrical performance, wherein conductive sections of the conductive cords are branched to connect to contacts of light sources. As a result, in existing configurations, none of the three conductive wires of the twisted cable is parallel to either of the two other conductive wires. Further, a length of the twisted cable is quite limited, e.g., less than about 300 feet, since a twisting force exerted on different portions of the twisted wire is non-uniform during a manufacturing process of the twisted wire, and the twisting force will accumulate during a twisting process conducted along a twisted length. As a result, the twisting force would be greater in a beginning portion and continually decreasing along the conductive wires until an end portion. When a length of the conductive wires to be twisted is too great, e.g., exceeding about 300 feet, the twisting force exerted on the beginning portion will be sufficient to damage or break the beginning portion when production machinery continually twists the conductive wires. Thus, the proposed light string 100 can eliminate shortcomings of the existing twist-type light strings with a commercially feasible manufacturing process since the proposed light string 100 is manufactured free of any twisting process. Further, the proposed light string 100 employs parallel conductive wires 102A to 102C joined side by side to enhance durability against external stress while still complying with the manufacturing specifications of the conductive wires 102A to 102C. Thus, consumers can therefore obtain light strings in lengths according to their own preference.

As discussed previously, according to some embodiments, the transformer 108 is configured to supply a first terminal (+) and a second terminal (−) configured to supply a power signal and a ground reference. In that case, the conductive wires 102A and 102C are electrically connected to the first terminal (+) and the second terminal (−), respectively, or vice versa. Direct current (DC) flows from the conductive wires 102A to the conductive wire 102B through the first-type light source 104, and from the conductive wire 102B to the conductive wire 102C through the third-type light source 104. According to some other embodiments where the mains electricity is directly provided to the conductive wire 102, a rectifier may be arranged between the plug of the mains electricity and the light sources 104. The rectifier, e.g., a bridge rectifier, is used to convert alternating current to direct current before the current flows through the light sources. In that situation, the bridge rectifier may be configured to provide a three-terminal output including an AC power signal, a ground signal and a rectified DC signal. The AC power signal and the ground signal may be electrically connected to the conductive wires 102A and 102C, respectively, while the rectified DC signal may be electrically connected to the conductive wire 102B. Thus, all of the light sources 104 in the light string 100 may include only the second-type light sources 104, and the first-type and third-type light sources 104 may be omitted. According to some embodiments, a serial-connection circuit 110-k may include two bridge rectifiers on two ends thereof to ensure the proper functioning of the serial-connection circuit 110-k.

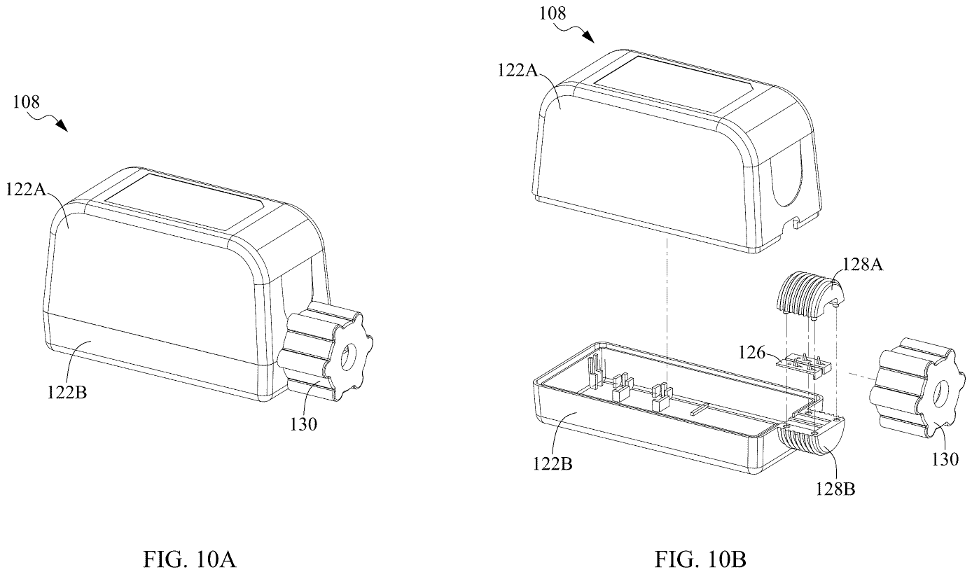

FIGS. 10A and 10B are an assembled view and an exploded view, respectively, of the transformer 108 of the light string 100, in accordance with some embodiments of the present disclosure. Referring to FIGS. 10A and 10B, the transformer 108 includes an upper casing 122A, a lower casing 122B, a spacer 126 and a fastener 130. According to some embodiments, the transformer 108 further includes an upper clamp 128A, and the lower casing 122B includes a lower clamp 128B. According to some embodiments, the transformer 108 can be detached or disassembled, such that customers can attach and electrically connect the custom-made light string 100 to the detached transformer 108 and assemble the transformer 108 after attachment of the custom-made light string. According to some embodiments, the fastener 130 is configured to join the upper casing 122A and the lower casing 122B by assembling the upper clamp 128A, the lower clamp 128B, the spacer 126 and the conductive wires 102A, 102B and 102C. According to some embodiments, the transformer 108 includes two spacers 126 to fix and hold the conductive wires 102A, 102B and 102C.

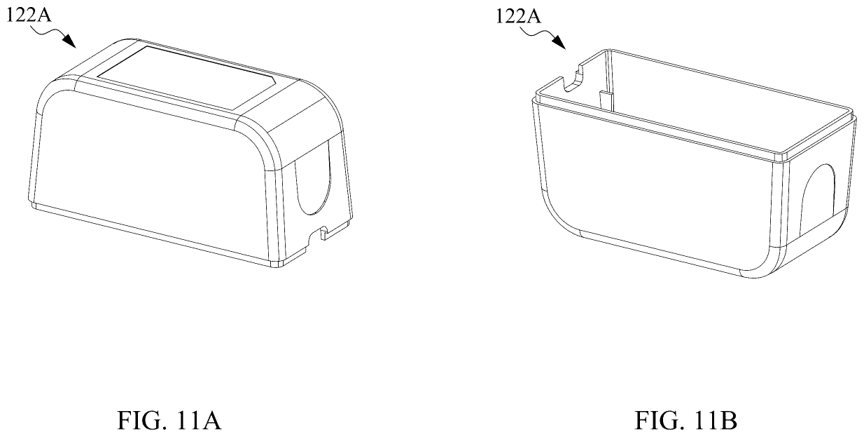

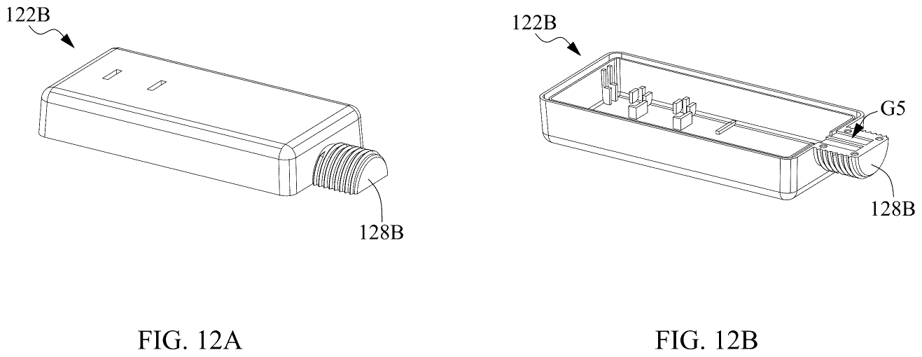

FIGS. 11A and 11B are perspective views of the upper casing 122A of the transformer 108 shown in FIGS. 10A and 10B, in accordance with some embodiments of the present disclosure. FIGS. 12A and 12B are perspective views of the lower casing 122B of the transformer 108 shown in FIGS. 10A and 10B, in accordance with some embodiments of the present disclosure. According to some embodiments, the lower casing 122B is integrated with the lower clamp 128B, but the present disclosure is not limited thereto. The upper casing 122A and the lower casing 122B may jointly define a cavity used to accommodate transformer circuits (not separately shown), such as a circuit board, a coil, a capacitor, an inductor and other electrical components. The upper casing 122A and the lower casing 122B may include special designs to fit together, such as a tab-and-slot design, on edges of the upper casing 122A and the lower casing 122B, such that the upper casing 122A and the lower casing 122B can form a sealed space.

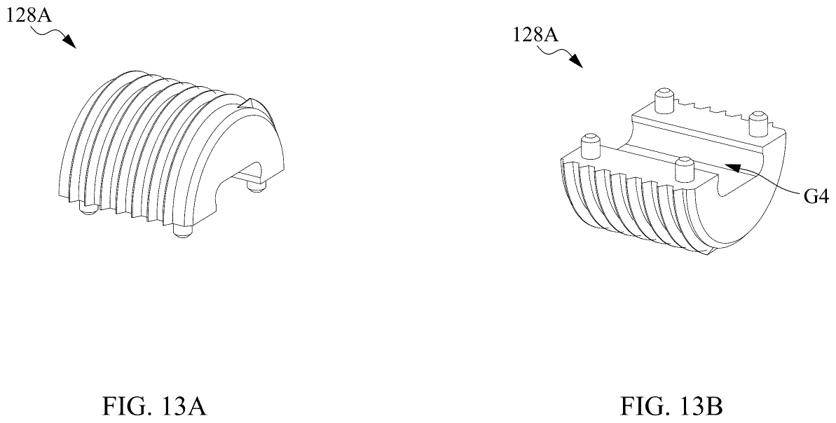

FIGS. 13A and 13B are perspective views of the upper clamp 128A of the transformer shown in FIG. 10B, in accordance with some embodiments of the present disclosure. According to some embodiments, the upper clamp 128A is used along with the lower clamp 128B to clamp the spacer 126 and the conductive wires 102A, 102B and 102C when the fastener 130 fastens the upper clamp 128A and the lower clamp 128B. Each of the upper clamp 128A and the lower clamp 128B may include a half-cylindrical shape with external screw threads formed on a curved portion of an outer surface of a half-cylinder. According to some embodiments, referring to FIG. 13B, the upper clamp 128A includes a groove G4 formed in a planar surface of the half-cylinder. Similarly, referring to FIG. 12B, the lower clamp 128B includes two grooves G5 formed in a planar surface of the half-cylinder. In alternative embodiments, a number of the grooves G5 is one or greater than two. The grooves G4 and G5 may be used to accommodate the spacers 126 and the ribbon wire 102 where the ribbon wire 102 traverses a space between the upper clamp 128A and the lower clamp 128B.

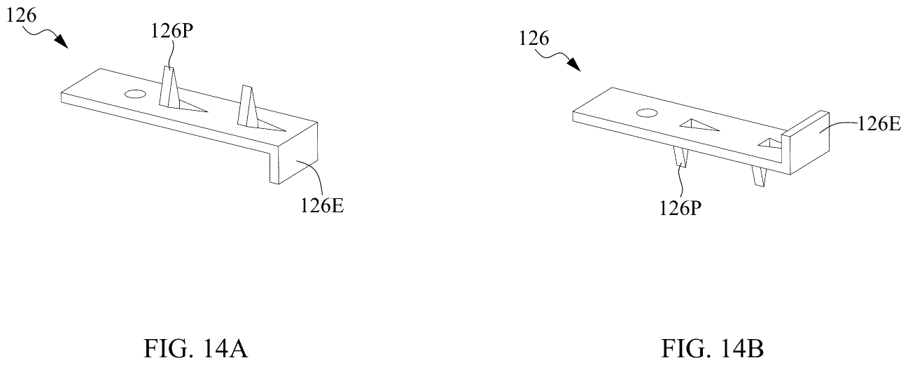

FIGS. 14A and 14B are perspective views of the spacer 126 of the transformer 108 shown in FIG. 10B, in accordance with some embodiments of the present disclosure. According to some embodiments, the spacer 126 includes one or more protrusions 126P arranged on a first side of the spacer 126 and used to secure and fix the conductive wires 102A, 102B and 102C between the upper clamp 128A and the lower clamp 128B. According to some embodiments, the spacer 126 further includes an ear 126E on one end of the spacer 126. The ear 126E may be fitted into a recess of the lower clamp 128B and used to retain the spacer 126 in place.

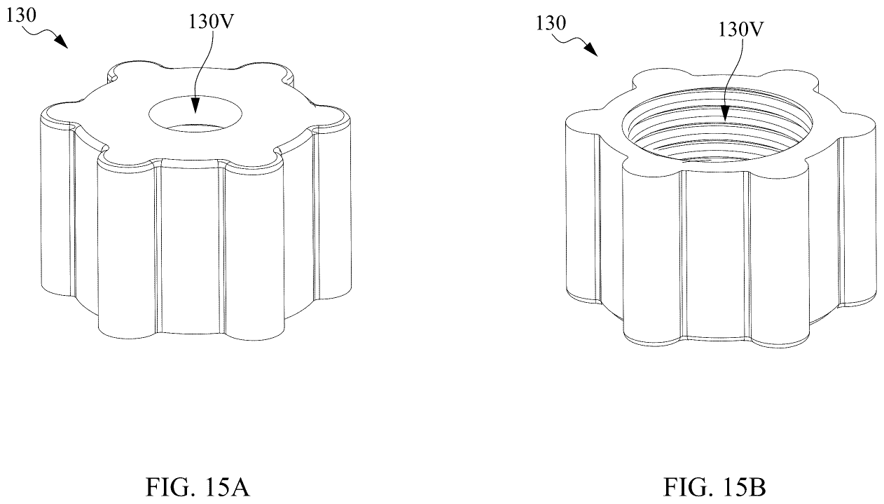

FIGS. 15A and 15B are perspective views of the fastener 130 of the transformer 108 shown in FIG. 10B, in accordance with some embodiments of the present disclosure. According to some embodiments, the fastener 130 has a shape similar to a machine nut and includes internal screw threads. In other embodiments, the fastener 130 may have another shape or configuration, and the present disclosure is not limited thereto. The fastener 130 may further include a via 130V extending through the fastener 130. Referring to FIGS. 10A and 10B, when the fastener 130 is used to assemble the upper casing 122A and the lower casing 122B with the custom-made light string 100, the fastener 130 is screwed onto the upper clamp 128A and the lower clamp 128B until the upper clamp 128A and the lower clamp 128B are securely fastened.

The foregoing outlines structure of several embodiments so that those skilled in the art may better understand the aspects of the present disclosure. Those skilled in the art should appreciate that they may readily use the present disclosure as a basis for designing or modifying other operations and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A light string, comprising:
a first conductive wire ;
a second conductive wire;
a third conductive wire, wherein the second conductive wire is parallel to the first conductive wire and the third conductive wire throughout an entire length of the second conductive wire; and
a plurality of light sources, each including two leads, wherein at least one of the two leads of each of the plurality of light sources is electrically coupled to the second conductive wire.

2. The light string of claim 1, wherein the first conductive wire, the second conductive wire and the third conductive wire are joined together side by side to form a ribbon wire.

3. The light string of claim 1, wherein one of the first conductive wire and the third conductive wire is electrically connected to a power signal, while another of the first conductive wire and the third conductive wire is electrically connected to ground.

4. The light string of claim 1, wherein the second conductive wire is partitioned into a plurality of conductive segments separate from each other.

5. The light string of claim 4, further comprising a plurality of separators electrically insulating adjacent ones of the conductive segments.

6. The light string of claim 5, wherein each of the plurality of separators comprises a main plate and an insulating plate substantially perpendicular to the main plate, wherein the insulating plate extends into a space between adjacent ones of the conductive segments and electrically insulates the adjacent conductive segments from one another.

7. The light string of claim 6, wherein each of the separators comprises a first guide hole, a second guide hole and a third guide hole, wherein the first guide hole and the second guide hole vertically overlap the second conductive wire, and the third guide hole vertically overlaps one of the first conductive wire and the third conductive wire.

8. The light string of claim 7, wherein each of the two leads of each of the plurality of light sources is electrically connected to the first conductive wire, the second conductive wire or the third conductive wire through one of the first guide hole, the second guide hole and the third guide hole.

9. The light string of claim 7, wherein the main plate further comprises a fourth guide hole vertically overlapping another of the first conductive wire and the third conductive wire.

10. The light string of claim 7, wherein the first guide hole and the second guide hole vertically overlap two adjacent ones of the conductive segments.

11. A light string, comprising:
a first conductive wire;
a second conductive wire, comprising a plurality of conductive segments electrically separate from each other;
a third conductive wire; and
a plurality of light sources, each including two leads, wherein one of the two leads of each of the plurality of light sources is electrically coupled to the first conductive wire, the third conductive wire, or one of the conductive segments of the second conductive wire.

12. The light string of claim 11, further comprising a plurality of separators arranged between the first, second and third conductive wires and the corresponding light sources.

13. The light string of claim 12, wherein each of the separators comprises a first guide hole, a second guide hole and an insulating plate between the first guide hole and the second guide hole.

14. The light string of claim 13, wherein each of the separators further comprises a third guide hole adjacent to the insulating plate between the first guide hole and the second guide hole.

15. The light string of claim 14, wherein a first distance between the first guide hole and the second guide hole is substantially equal to a second distance between the first guide hole and the third guide hole.

16. The light string of claim 11, wherein the first conductive wire and the third conductive wire are conductive throughout an entire length of the second conductive wire.

17. The light string of claim 11, wherein the plurality of light sources comprise at least one first-type light source, a plurality of second-type light sources, and at least one third-type light source, wherein the two leads of each of the first-type light sources are electrically connected to the first conductive wire and the second conductive wire, respectively, the two leads of each of the second-type light sources are electrically connected to adjacent conductive segments of the second conductive wire, and the two leads of each of the third-type light sources are electrically connected to the second conductive wire and the third conductive wire, respectively.

18. The light string of claim 17, wherein the first conductive wire, the second conductive wire and the third conductive wire are configured to form a plurality of circuits electrically connected in parallel, wherein each of the circuits comprises a subset of the plurality of light sources electrically connected in series.

19. The light string of claim 18, wherein one of the conductive segments of the second conductive wire arranged between two adjacent circuits is electrically floating.

20. The light string of claim 11, further comprising a transformer electrically coupled to one end of each of the first, second and third conductive wires.
